(19) United States
(12) Patent Application Publication
(10) Pub. No.: US 2005/0219284 A1
(43) Pub. Date: Oct. 6, 2005

(54) Refill management system

(75) Inventor: Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/090,303

(22) Filed: Mar. 28, 2005

(30) Foreign Application Priority Data
Mar. 29, 2004 (JP) 2004-95818
Mar. 29, 2004 (JP) 2004-95843

(51) Int. Cl. B41J 2/195

(52) U.S. Cl. 347/7

(57) ABSTRACT

A printer 200 uploads the identification number and ink remaining amount regarding the ink cartridge 270 mounted therein to the server 100 over a network 300. The server 100 keeps track of the identification information and ink remaining amount for each ink cartridge using a remaining amount management table 142. Where the ink remaining amount uploaded with regard to an identification number is larger than the ink remaining amount registered in the remaining amount management table in association with that identification number, the ink cartridge having such identification number is determined to be a refilled cartridge, and such identification number and the number of refills associated therewith are kept track of using a refill management table 144. As a result, it can be easily determined whether or not a consumable item container mounted in a device is a refilled container, and even if a refilled container is shared among multiple devices, the number of refills performed thereto can be easily monitored.

### BACKGROUND OF THE INVENTION

1. Field of the Invention

The present invention relates to a technology to determine whether or not a consumable item container (such as an ink cartridge or toner cartridge) mounted in a device (such as a printer) is a refilled container, as well as a technology to keep track of the number of times that the consumable item container has been refilled with the consumable item.

2. Description of the Related Art

Devices connected to a network includes devices that are used while a consumable item container filled with a consumable item is mounted therein. In such a device, if all of the consumable item inside the container has been consumed, the container itself is generally replaced with an unused container filled with the consumable item, but depending on the situation, the consumable item container is not replaced but is simply refilled with the consumable item for further use.

For example, inkjet printers are used to perform various types of printing using an internally mounted ink cartridge filled with ink, and in some such printers, when all of the ink inside the ink cartridge has been consumed, the ink cartridge is replaced with a new ink cartridge before the printer is used again, but in other such printers, the ink cartridge is refilled with new ink and reused.

However, where the consumable item container is reused while it is refilled with the consumable item, if the container is refilled a large number of times, the device including the consumable item container may become adversely impacted.

For example, in an inkjet printer, if the same ink cartridge is repeatedly refilled with ink, the printing quality may deteriorate or the durability of the printer engine may be affected.

Therefore, determining whether or not a consumable item container mounted in a device is a consumable item container that has been refilled (hereinafter ‘refilled container’) is important.

Relevant technologies for performing this determination include, for example, the technology disclosed in Japanese Patent Laid-Open Gazette No. 2003-320658.

Where more than one such device is connected to a network, a single consumable item container may be refilled and shared among the multiple devices. In such a case, the number of times that the consumable item container has been subjected to refill (i.e., the number of refills) is tracked difficultly in the conventional art.

At the same time, a device driver to drive the device is provided by the device manufacturer or a company affiliated therewith (hereinafter ‘the device manufacturer or the like’), and is designed to drive the device in the optimal fashion when the consumable item manufactured by the device manufacturer or the like is used.

However, where the consumable item container is refilled by a party other than the device manufacturer or the like, the characteristics of the consumable item used often differ from the characteristics of the original item, and as a result the device may not be driven in the optimal fashion and may be adversely impacted.

For example, in an inkjet printer, when an ink cartridge has been refilled with ink by a party other than the printer manufacturer or the like, there is a risk that the printing quality may deteriorate or the durability of the printer engine may be impacted.

### SUMMARY OF THE INVENTION

Accordingly, an object of the present invention is to resolve the problems described above and to provide a technology that enables it to be easily determined whether or not a consumable item container mounted in a device is a refilled container, and that, even if the refilled container is shared among multiple devices, enables the number of refills performed to be easily tracked, as well as a technology that prevents adverse impacts on the device due to excessive refills of the same consumable item container or refills performed by a party other than the device manufacturer or the like.

In order to attain at least part of the above and the other related objects, the present invention is directed to a first refill management system that comprises a server and devices connected to the server over a network and that keeps track of refills of the consumable item container mounted in each the device, wherein each the device sends to the server over the network identification information by which to identify the consumable item container mounted therein and remaining amount related information that indicates the remaining amount of the consumable item in the consumable item container or an amount related thereto, and wherein the server comprises a first management table that stores and associates, for each the consumable item container, the identification information and the remaining amount related information, where identification information sent from a device is already registered in the first management table, compares a first remaining amount derived from the remaining amount related information sent from the device and a second remaining amount derived from remaining amount related information previously registered in the first management table in association with the identification information sent from the device, and where the first remaining amount is larger than the second remaining amount, determines that the consumable item container mounted in the device has been refilled.

In the first system of the present invention, a device sends to the server over the network the identification information regarding the consumable item container mounted therein and the remaining amount related information regarding such consumable item container. Where the identification information sent from the device is already registered in the first management table, the server compares a first remaining amount derived from the remaining amount related information received from the device and a second remaining amount derived from remaining amount related information previously registered in association with the identification information for the device. If the first remaining amount is larger than the second remaining amount, the server determines that the consumable item container mounted in the device has been refilled.

Therefore, according to the first system of the present invention, the server can easily determine whether or not the consumable item container mounted in a device connected to a network is a refilled container.

The information related to the remaining amount of the consumable item includes the consumed amount and refillable amount of the consumable item. Therefore, direct comparison and determination using such consumed amount or refillable amount of the consumable item is also essentially equivalent to ‘compares a first remaining amount derived from the remaining amount related information sent from the device and a second remaining amount derived from remaining amount related information previously registered in the first management table in association with the identification information sent from the device, and where the first remaining amount is larger than the second remaining amount, determines that the consumable item container mounted in the device has been refilled.’

In the first system of the present invention, it is preferred that the server further comprises a second management table that stores and associates, for each the consumable item container, identification information and the number of times that the consumable item container have been refilled, and where it is determined that a consumable item container has been refilled, the number of refills registered in the second management table in association with the identification information for the consumable item container is incremented.

Using this construction, even if a single consumable item container is refilled and shared among devices connected to a network, because the server keeps track of the number of refills for each consumable item container, the number of refills for the above consumable item container can be easily learned.

In the first system of the present invention, it is preferred that the server registers the remaining amount related information sent from any of the device in the first management table in association with the sent identification information.

As a result, the latest information is registered at all times in the first management table in the server as remaining amount management information, based on which it can be more accurately determined whether or not a consumable item container is a refilled container.

In the first system of the present invention, it is preferred that each the device comprises a reader that reads the identification information from the consumable item container mounted therein and a detector that detects the remaining amount of the consumable item in the consumable item container or a different amount related thereto.

As a result, the devices can reliably obtain the identification information and the remaining amount related information regarding the consumable item container mounted therein and send them to the server. The detector may be disposed inside or outside the consumable item container in the device.

The present invention is directed to a second refill management system that includes a server and devices connected to the server over a network and that keeps track of refills of the consumable item container mounted in each the device, wherein the server comprises a management table that stores and associates, for each the consumable item container, identification information by which to identify the consumable item container and the number of refills representing the number of times that the consumable item container has been refilled, and compares, with regard to the consumable item container mounted in each the device, the number of refills registered in the management table in association with the identification information for the consumable item container and a preset maximum limit, and where the number of refills exceeds the maximum limit, sends a predetermined message to the device, and wherein the device receives the message sent from the server and announces it externally.

As described above, in the second system of the present invention, the server compares, with regard to the consumable item container mounted in a device, the number of refills registered in the management table in association with the identification information for the consumable item container and a preset maximum limit. If the number of refills exceeds the maximum limit, the server sends a predetermined message to the device. The device receives the message and announces it externally.

As a result, according to the second system of the present invention, even if the same consumable item container is refilled repeatedly, where the number of refills exceeds the maximum limit, a predetermined message is announced from the printer and attracts the attention of the printer user, enabling adverse impacts on the printer due to excessive refills of the same consumable item container to be prevented.

The method for the printer to announce the message externally may comprise display of the message on a display panel, inclusion of the message on a Web page offered by the printer, audio communication of the message using a speaker or the like, or printing of the message.

The present invention is directed to a third refill management system that includes a server and devices connected to the server over a network and that keeps track of refills of the consumable item container mounted in each the device, wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith, compares, with regard to the consumable item container mounted in each the device, the first number of refills and the second number of refills that are registered in the management table in association with the identification information for the consumable item container, and where the first number of refills exceeds the second number of refills, sends a predetermined message to the device; and the device receives the message sent from the server and announces it externally.

As described above, in the third system of the present invention, the server compares, with regard to the consumable item container mounted in a device, the first number of refills and the second number of refills (i.e., the number of refills performed by the device manufacturer or the like) that are registered in the management table in association with the identification information for the consumable item container. If the first number of refills exceeds the second number of refills, the difference can be deemed to indicate a refill performed by a party other than the device manufacturer or the like, and as a result, the server sends a prescribed message to the device. The device receives the message and announces it externally.

Therefore, according to the third system of the present invention, because when a refill of a consumable item container has been performed by a party other than the device manufacturer or the like, a predetermined message is announced from the printer and attracts the attention of the printer user, enabling adverse impacts on the printer due to excessive refills of the consumable item container to be prevented.

‘A party affiliated with the device manufacturer’ includes a person or entity who manufactures or sells the consumable item container or the consumable item under the control of the device manufacturer.

The present invention is directed to a first server that is connected to devices over a network and can keep track of refills with regard to the consumable item container mounted in each the device, wherein the server comprises a management table that stores and associates, for each the consumable item container, identification information by which to identify the consumable item container and the number of refills representing the number of times that the consumable item container has been refilled, the server compares, with regard to the consumable item container mounted in each the device, the number of refills registered in the management table in association with the identification information for the consumable item container and a preset maximum limit, and where the number of refills exceeds the maximum limit, sends a predetermined message to the device.

Using this first server, the same effect as that obtained by the first system described above can be obtained.

The present invention is directed to a second server that is connected to devices over a network and can keep track of refills with regard to the consumable item container mounted in each the device, wherein the server comprises a management table that stores and associates, for each the consumable item container, identification information by which to identify the consumable item container and the number of refills representing the number of times that the consumable item container has been refilled, the server compares, with regard to the consumable item container mounted in each the device, the number of refills registered in the management table in association with the identification information for the consumable item container and a preset maximum limit, and where the number of refills exceeds the maximum limit, sends an e-mail to at least the administrator of the system including the server, a service representative who can perform maintenance to the device or the user of the device.

As described above, the second server of the present invention compares with regard to the consumable item container in each device the number of refills registered in the management table in association with the identification information for the consumable item container and a preset maximum limit. Where the number of refills exceeds the maximum limit, an e-mail is sent to at least either the administrator, a service representative or the user.

Therefore, according to the second server of the present invention, because even if the same consumable item container is repeatedly refilled, if the number of such refills exceeds the maximum limit, an e-mail is sent to either the administrator, a service representative or the user, that person's attention can be drawn to the fact that the number of refills exceeds the maximum limit.

The terms ‘administrator’, ‘service representative’ and ‘user’ include not only an individual but also a group such as a section or department and an organization such as a company.

The present invention is directed to a third server that is connected to devices over a network and can keep track of refills with regard to the consumable item container mounted in each such device, wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith, the server compares, with regard to the consumable item container mounted in each the device, the first number of refills and the second number of refills that are registered in the management table in association with the identification information for the consumable item container, and where the first number of refills exceeds the second number of refills, sends a predetermined message to the device.

By using the third server described above, the same effect obtained by the second system can be obtained.

The present invention is directed to a fourth server that is connected to devices over a network and can keep track of refills with regard to the consumable item container mounted in each such device, wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith,
the server compares, with regard to the consumable item container mounted in each the device, the first number of refills and the second number of refills that are registered in the management table in association with the identification information for the consumable item container, and where the first number of refills exceeds the second number of refills, sends an e-mail to at least the administrator of the system including the server, a service representative who can perform maintenance to the device or the user of the device.

As described above, the fourth server of the present invention compares, with regard to the consumable item container mounted in each device, the first number of refills and the second number of refills (i.e., the number of refills performed by the manufacturer or the like) that are registered in the management table in association with the identification information regarding the consumable item container. If the first number of refills exceeds the second number of refills, the difference can be deemed to indicate a refill performed by a party other than the device manufacturer or the like, and as a result, an e-mail is sent to the administrator, a service representative or the user.

According to the fourth server of the present invention, because if a refill is performed by a party other than the device manufacturer or the like, an e-mail is sent to either the administrator, a service representative or the user, that person's attention can be drawn to the fact that a refill has been performed by a party other than the device manufacturer or the like.

The present invention may be applied not only in the refill management system or server described above but also in a device. The present invention is also not limited to the form of a device but may be realized as a method such as a refill management method. Moreover, the present invention may be realized in various other forms, including a computer program to execute such method or device, a recording medium on which such computer program is recorded, or data signals carried on carrier waves including such computer program.

Where the present invention is constructed as a computer program or a recording medium or the like on which such computer program is recorded, such computer program or recoding medium may comprise or include an entire program that controls the server or a program that includes only the functions of the present invention. For the recording medium, various types of computer-readable media can be used, including a flexible disk, a CD-ROM, a DVD-ROM, a magneto-optical disk, an IC card, a ROM cartridge, a punch card, printed matter on which a symbol such as a bar code is printed, a computer's internal storage device (i.e., a memory such as a RAM or ROM), or an external storage device.

### BRIEF DESCRIPTION OF THE DRAWINGS

FIG. 1 is a block diagram showing a refill management system comprising a first embodiment of the present invention;

FIG. 2 is a flow chart showing the operations of an ink remaining amount upload routine executed on the printer 200 shown in FIG. 1;

FIG. 3 is a flow chart showing the operations of a refilled cartridge determination routine executed on the server 100 shown in FIG. 1;

FIG. 4 is an explanatory drawing showing one example of the remaining amount management table 144 shown in FIG. 1;

FIG. 5 is an explanatory drawing showing one example of the refill management table 144 shown in FIG. 1;

FIG. 6 is a block diagram showing a refill management system comprising a second embodiment of the present invention;

FIG. 7 is a flow chart showing the operations of a refilled cartridge determination routine executed on the server 100 shown in FIG. 6;

FIG. 8 is an explanatory drawing showing one example of the refill management table 144 shown in FIG. 6; and

FIG. 9 is a flow chart showing the operations of a number of refills determination routine shown in FIG. 7.

### DESCRIPTION OF THE PREFERED EMBODIMENTS

Embodiments of the present invention are described below based on examples in the following sequence.
I. First Embodiment
I-A. Construction of Embodiment
I-B. Operation of Embodiment
I-B-1. Operations Executed on Printer
I-B-2. Operations Executed on Server
I-C. Effect of Embodiment
II. Second Embodiment
II-A. Construction of Embodiment
II-B. Operation of Embodiment
II-B-1. Operations Executed on Server
II-B-2. Operations Executed on Printer
II-C. Effects of Embodiment
III. Variations

### I. First Embodiment

### I-A. Construction of Embodiment

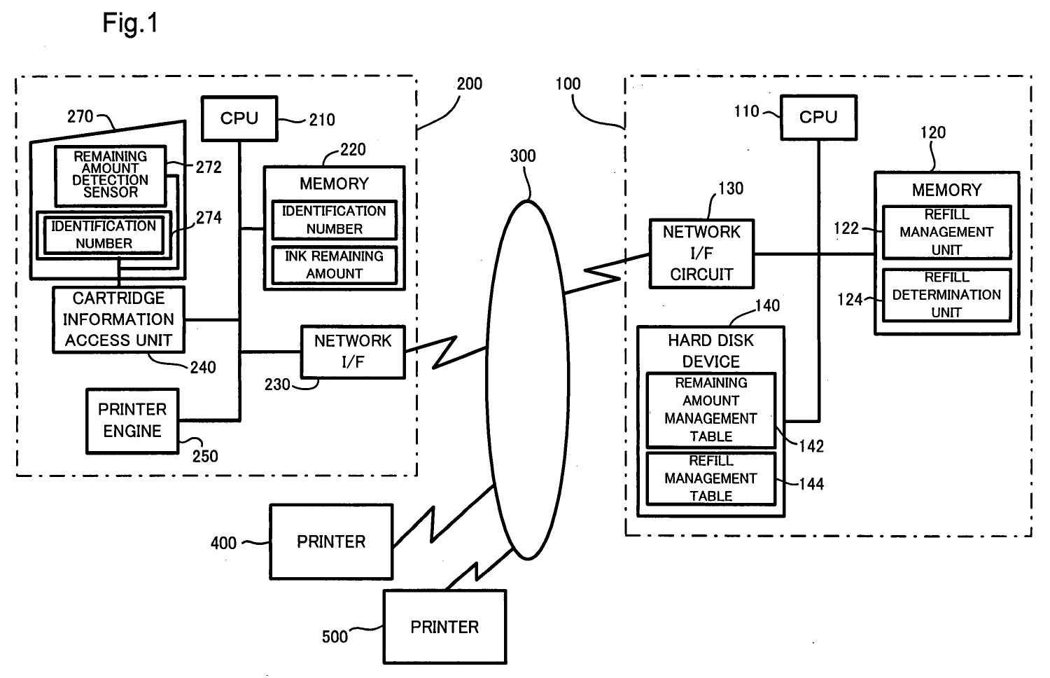

FIG. 1 is a block diagram showing a refill management system comprising a first embodiment of the present invention. As shown in FIG. 1, the refill management system of this embodiment comprises a server 100 and printers 200, 400, 500 that are mutually connected over a network 300. In this embodiment, these printers 200, 400, 500 are inkjet printers.

The server 100 includes a CPU 110 that executes various types of processing and control according to a program, a memory 120 that stores this program and temporarily stores data and the like obtained during processing, a network interface (hereinafter abbreviated as ‘I/F’) circuit 130 that performs communication with other devices over the network 300, and a hard disk device 140 that stores the various tables, as shown in FIG. 1.

The server 100 also includes input devices such as a keyboard, mouse and/or tablet that are used to input instructions from the administrator, for example, as well as a monitor that comprises a CRT or a liquid crystal display and displays data contents, but these components are omitted from FIG. 1.

The CPU 110 functions as a refill management unit 122 and refill determination unit 124 by executing the program mentioned above that is stored in the memory 120. The hard disk device 140 has, as described below, a remaining amount management table 142 that is used to keep track of the remaining amount of the ink in the ink cartridge, and a refill management table 144 that is used to keep track of the number of refills of the ink cartridge.

The above program may be provided to the server 100 using a CD-ROM, a DVD-ROM, a memory card or the like, or may be incorporated in the server 100 over the network 300 from a program server (not shown) that provides programs. The operating system program may comprise part of such program. In this embodiment, the refill management unit 122 and refill determination unit 124 are realized via software, but they may be realized via hardware instead.

At the same time, the printer 200 includes, like the server 100, a CPU 210 that executes various types of processing and control according to a program, a memory 220 that stores this program and temporarily stores data and the like obtained during processing, and a network I/F circuit 230 that performs communication with other devices over the network 300. In addition, it also includes a cartridge information access unit 240 that obtains various types of information from an ink cartridge 270 mounted in the printer 200 and a printer engine 250 comprising the mechanism that actually performs printing.

The ink cartridge 270 houses ink (not shown) therein, and includes a remaining amount detection sensor 272 that detects the remaining amount of the ink and an IC 274 that stores information. On the IC 274 is stored a unique identification number given to the ink cartridge 270 in order to identify it.

The other printers 400, 500 have a construction identical to that of the printer 200, and therefore will not be described herein.

For the network 300, any of various types of networks can be used, such as the Internet, a local area network (LAN), a wide area network (WAN) or a telephone network.

### I-B. Operation of Embodiment

### I-B-1. Operations Executed on Printer

The operations executed on the printer shown in FIG. 1 will first be described. Because all of the printers execute the same operations, the operations executed on the printer 200 will be described as a representative example, and those executed on the other printers will not be described herein. In addition, among the operations executed on the printer, public-domain operations such as the printing operation will be omitted from the description, and ink remaining amount upload processing, which comprises a characteristic of the present invention, will be described in detail below.

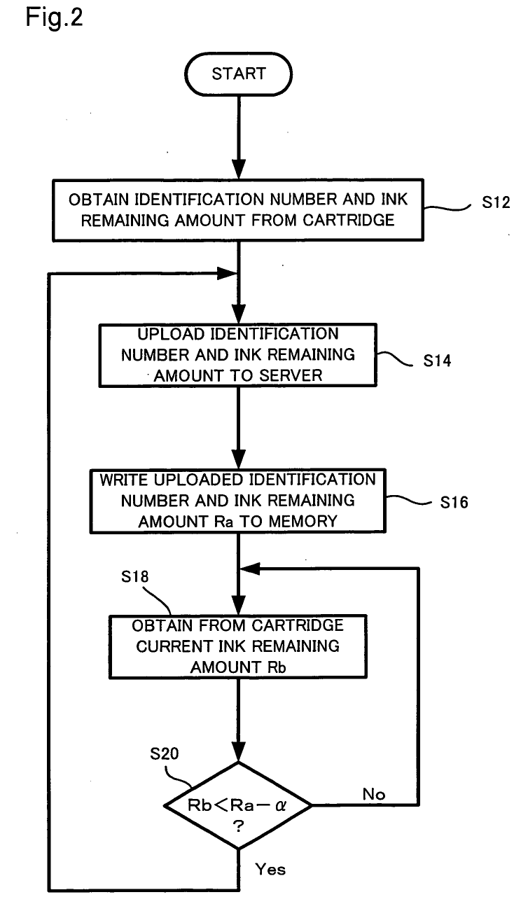

FIG. 2 is a flow chart showing the operations of an ink remaining amount upload routine executed on the printer 200 shown in FIG. 1. The ink remaining amount upload routine shown in FIG. 2 is begun when the printer 200 is powered ON or when a new ink cartridge 270 is mounted in the printer 200 to replace the existing ink cartridge 270, for example.

When this routine is begun, the CPU 210 first accesses the ink cartridge 270 via the cartridge information access unit 240 to read and obtain the identification number from the IC 274 of the ink cartridge 270. In the ink cartridge 270, the remaining amount detection sensor 272 detects the ink remaining amount remaining in the ink cartridge 270, and the CPU 210 obtains the detected ink remaining amount from the remaining amount detection sensor 272 (step S12).

The remaining amount detection sensor 272 measures the level of the ink surface in the ink cartridge 270, for example, and calculates the ink remaining amount from the measurement result. Here, when the ink surface is at the maximum level, the ink remaining amount is deemed to be 100%, and when the ink surface level is essentially zero, the ink remaining amount is deemed to be 0%.

The CPU 210 then accesses the server 100 via the network I/F circuit 230 over the network 300, and uploads to the server 100 the identification number of the ink cartridge 270 and the ink remaining amount it has obtained (step S14). The operations executed on the server are described below.

The CPU 210 then writes the uploaded identification number and ink remaining amount to the memory 220 (step S16). The ink remaining amount written in this operation is deemed Ra [%].

Subsequently, the CPU 210 accesses the ink cartridge 270 via the cartridge information access unit 240 each time printing is carried out (or at certain intervals) to obtain from the remaining amount detection sensor 272 the ink remaining amount that is available at such time of access (step S18). The ink remaining amount obtained in this operation is deemed Rb [%].

The CPU 210 then reads the uploaded ink remaining amount Ra from the memory 220 and compares it with the current ink remaining amount Rb previously obtained from the remaining amount detection sensor 272. It then determines whether or not the current ink remaining amount Rb is smaller than the uploaded ink remaining amount Ra by an amount a [%], i.e., whether Rb<Ra−a (step S20). a is set in advance as an appropriate value based on the amount of ink ordinarily used by the printer for printing.

Where it is determined that the current ink remaining amount Rb is not yet smaller than the uploaded ink remaining amount Ra by the amount a, the CPU 210 returns to step S18 and accesses the ink cartridge 270 again when the next printing session is carried out (or after a certain period of time has elapsed), obtains the ink remaining amount available at the time of this access from the remaining amount detection sensor 272 and repeats the subsequent operations described above.

Conversely, where it is determined that the current remaining amount Rb is smaller than the uploaded ink remaining amount by the amount a, the CPU 210 reruns to step S14, and accesses the server 100 again to upload to the server 100 the ink cartridge 270 identification number and ink remaining amount thereof obtained from the remaining amount detection sensor 272 and repeats the subsequent operations as before.

The ink remaining amount upload routine shown in FIG. 2 is repeated in this way until power to the printer 200 is turned OFF.

Incidentally, if in order to replace the existing ink cartridge mounted in the printer 200, the cartridge is removed and a new ink cartridge is mounted while power to the printer 200 is ON, for example, because the remaining amount upload routine shown in FIG. 2 is begun anew as described above, the CPU 210 first obtains the identification number and ink remaining amount from the replacement ink cartridge 270 (step S12) and uploads these items of information to the server 100 (step S14). In this case, the identification number and ink remaining amount of the new ink cartridge 270, which are naturally different from the identification number and ink remaining amount of the old ink cartridge 270, are uploaded.

On the other hand, if the existing ink cartridge mounted in the printer 200 is removed, refilled with ink and returned to the printer 200 while the power to the printer 200 is ON, because the ink remaining amount upload routine shown in FIG. 2 is begun anew in the same way, the CPU 210 obtains the identification and ink remaining amount from the refilled ink cartridge 270 (step S12) and uploads these items of information to the server 100 (step S14). However, in this case, the same identification number is uploaded as the identification number for the ink cartridge 270, and the ink remaining amount that is larger than the previously uploaded remaining amount by the amount of the refill is uploaded.

### I-B-2. Operations Executed on Server

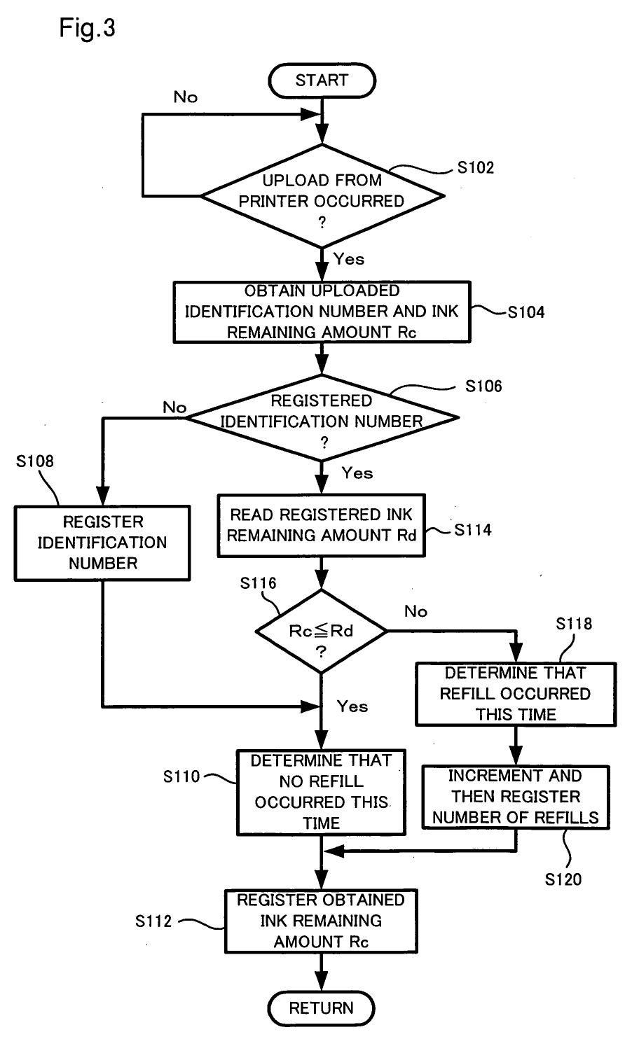

The operations executed on the server shown in FIG. 1 will now be described. FIG. 3 is a flow chart showing the operations of a refilled cartridge determination routine executed on the server 100 shown in FIG. 100.

When the processing routine shown in FIG. 3 is begun, the CPU 110 functions as the refill management unit 122 and refill determination unit 124 as described above. As between these two functions, the refill management unit 122 determines whether or not ink remaining amount and other information has been uploaded from any of the printers over the network 300 (step S102), and if no such information has been uploaded, the refill management unit 122 stands by until it is uploaded. When the information is thereafter uploaded from any of the printers, the refill management unit 122 obtains the uploaded identification number and ink remaining amount via the network I/F circuit 130 (step S104). The ink remaining amount obtained via uploading here is deemed Rc [%].

The refill management unit 122 then determines whether or not the identification number obtained via uploading is a registered identification number (step S106) with reference to the remaining amount management table 142 and the like on the hard disk device 140. If it is unregistered, the identification number obtained via uploading is registered in the remaining amount management table 142 and the refill management table 144 (step S108).

The refill determination unit 124 then determines that the ink cartridge having the identification number obtained via uploading was not refilled this time (step S110), and the refill management unit 122 registers the previously obtained ink remaining amount Rc in the remaining amount management table 142 in association with the previously registered identification number (step S112), whereupon the processing routine ends.

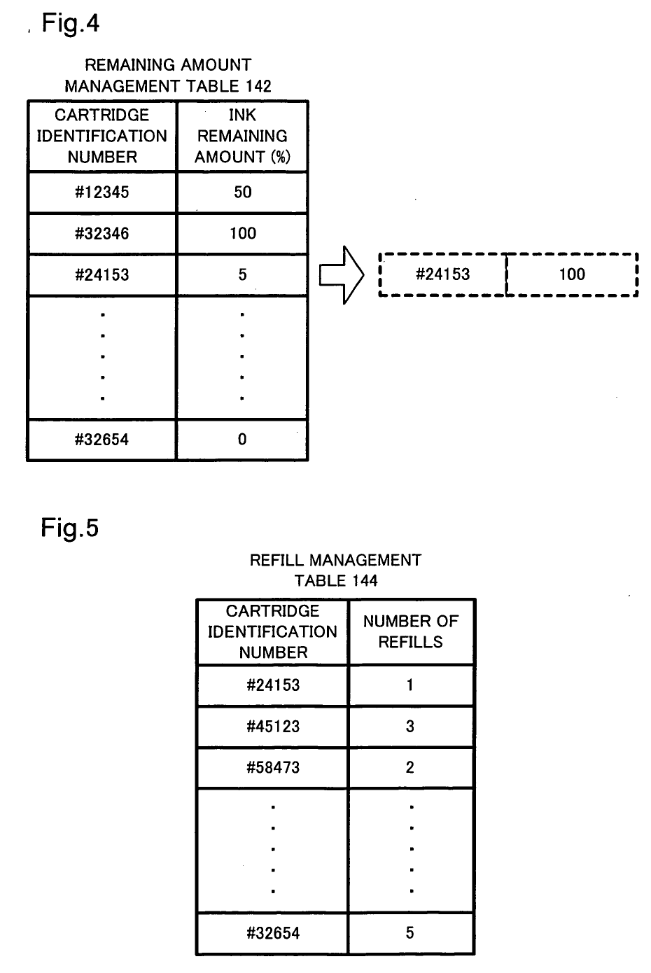

FIG. 4 is an explanatory drawing showing one example of the remaining amount management table 142 shown in FIG. 1. As shown in FIG. 4, the identification number and ink remaining amount are registered in association with each other for each ink cartridge in the remaining amount management table 142. These registered items of information comprise information regarding ink cartridges that are or were mounted in the printers connected to the network 300.

Therefore, as described above, where a new ink cartridge replaces the existing ink cartridge in the printer 200, for example, the identification number (such as ‘#12345’) and ink remaining amount of the existing ink cartridge are uploaded from the printer 200 to the server 100 and until replacement are registered in the remaining amount management table 142 as shown in FIG. 4, but after replacement, the identification number (such as ‘#32346’) and ink remaining amount of the new ink cartridge are uploaded and newly registered in the remaining amount management table 142 as shown in FIG. 4.

On the other hand, where it is determined by the refill management unit 122 in step S106 that the identification number obtained via uploading is already registered, the refill determination unit 124 reads from the remaining amount management table 142 on the hard disk device 140 the ink remaining amount corresponding to such registered identification number. The read ink remaining amount is deemed Rd [%].

The refill determination unit 124 then compares the ink remaining amount Rc obtained via uploading with the ink remaining amount Rd read from the remaining amount management table 142 to determine whether or not the ink remaining amount Rc equals or is smaller than the ink remaining amount Rd registered in the remaining amount management table 412, i.e., whether Rc≦Rd (step S116). In this case, it is preferred that the above determination be carried out while taking into account ink remaining amount measurement errors.

If it is determined that the ink amount Rc obtained via uploading equals or is smaller than the ink remaining amount Rd registered in the remaining amount management table 142, the refill determination unit 124 determines that the ink cartridge having the identification number obtained via uploading was not refilled this time (step S110), and the refill management unit 122 registers the ink remaining amount Rc obtained via uploading by overwriting the ink amount corresponding to the registered identification number obtained via uploading (step S112), whereupon the processing routine ends.

Conversely, where the ink amount Rc obtained via uploading is larger than the ink remaining amount Rd registered in the remaining amount management table 142, the refill determination unit 124 determines that the ink cartridge having the identification number obtained via uploading was refilled this time (step S118).

In other words, as described above, in the printer 200, when the ink cartridge is refilled with ink, prior to the refill, ‘5%’ was uploaded as the ink remaining amount in connection with the identification number of the ink cartridge (in this case ‘#24153’, for example) and was registered in the remaining amount management table 142 as shown in FIG. 4, while after the refill, because the amount of ink has increased in the same ink cartridge to the extent of the refill ink, as shown by the dotted lines in FIG. 4, ‘100%’ is uploaded, for example, as the ink remaining amount for the same ink cartridge identification number ‘#24153’.

Therefore, where the ink remaining amount Rc obtained via uploading (‘100%’ in the example described above) is larger than the ink remaining amount Rd registered in the remaining amount management table 142 with regard to the same identification number (‘#24153’ in the example described above), the ink cartridge can be determined to be a refilled cartridge.

The refill management unit 122 then increments the number of refills corresponding to the identification number obtained via uploading in the refill management table 144 on the hard disk device 140 and registers the resulting sum therein (step S120).

FIG. 5 is an explanatory drawing showing one example of the refill management table 144 shown in FIG. 1. As shown in FIG. 5, the identification number and the number of times that the ink cartridge has been refilled with ink (the number of refills) are registered in the refill management table 144 in association with each other for each ink cartridge. As in the case of the remaining amount management table 142, these registered items of information also comprise information regarding ink cartridges that are or were mounted in the printers connected to the network 300.

Where it is determined for the first time by the refill determination unit 124 that the ink cartridge having the identification number obtained via uploading is a refilled cartridge, the refill management unit 122 registers ‘1’ in the refill management table 144 as the number of refills for that identification number. Where the number of times that the ink cartridge having the identification number obtained via uploading has been determined by the refill determination unit 124 to be a refilled cartridge is two or more, the refill management unit 122 increments the number of refills for that registered identification number and registers the resulting sum in the refill management table 144.

Therefore, for example, in the printer 200, where an ink cartridge having the identification number ‘#24153’ is refilled for the first time, as described above, ‘1’ is registered as the number of refills corresponding to the identification number ‘#24153’ in the refill management table 144, as shown in FIG. 4.

Where an ink cartridge having the identification number ‘#45123’ has been refilled for the third time, for example, the registered number of refills for that identification number ‘#45123’ (i.e., ‘2’) is incremented to ‘3’, which is registered in the refill management table 144 as shown in FIG. 5.

The refill management unit 122 then registers the ink remaining amount Rc obtained via uploading in the remaining amount management table 142 by overwriting the ink remaining amount corresponding to the registered identification number obtained via uploading (step S112), whereupon the processing routine ends.

Therefore, as described above, for example, in the printer 200, where an ink cartridge having the identification number ‘#24153’ has been refilled and the identification number ‘#24153’ and ink remaining amount ‘100%’ are uploaded from the printer 200 to the server 100, as described above, the existing registered ink remaining amount ‘5%’ is overwritten with the new ink remaining amount ‘100%’ for the identification number ‘#24153’ in the remaining amount management table 142 and registered therein, as shown in FIG. 4.

In this way, the server 100 keeps track of the ink remaining amount in each ink cartridge that has been mounted in any of the printers connected to the network 300. When the identification number and ink remaining amount are uploaded from a printer, the server 100 determines whether or not the ink cartridge having that identification number is a refilled cartridge, and if it is a refilled cartridge, the server 100 keeps tracks of the number of refills as well.

### I-C. Effect of Embodiment

Therefore, according to this embodiment, the server 100 can easily determine whether or not the ink cartridge mounted in any of the printers connected to the network 300 is a refilled cartridge.

Even if a single ink cartridge is refilled and shared among the printers connected to the network 300, because the server 100 keeps track of the number of refills for each ink cartridge, as described above, the number of refills regarding the ink cartridge can be easily known.

### II. Second Embodiment

### II-A. Construction of Embodiment

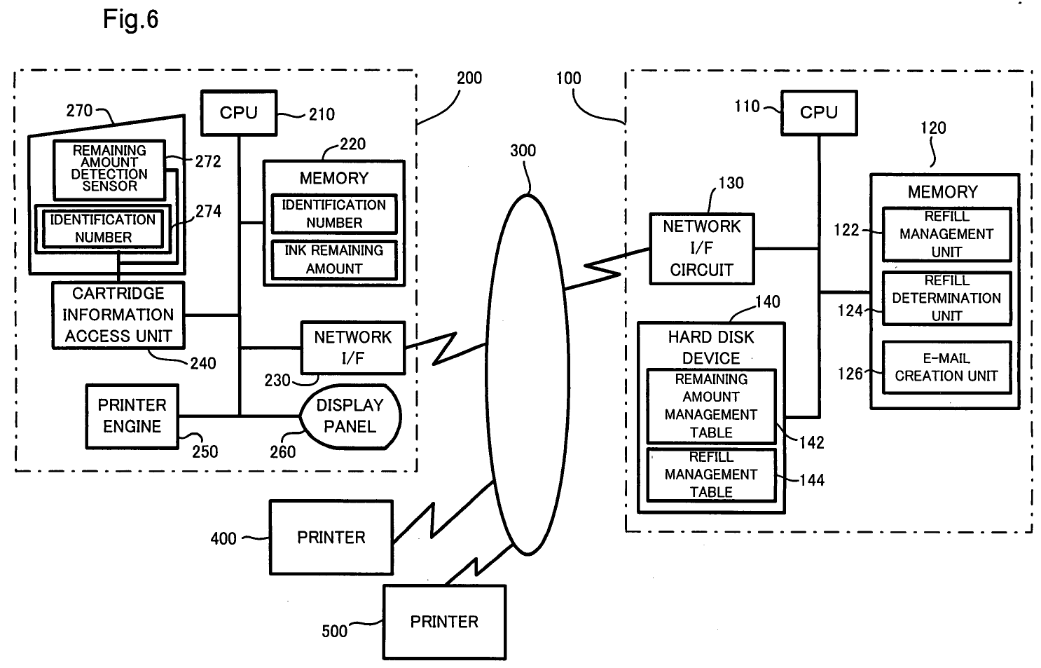

FIG. 6 is a block diagram showing a refill management system comprising a second embodiment of the present invention. As shown in FIG. 6, the refill management system of this embodiment has essentially the same construction as the refill management system of the first embodiment shown in FIG. 1, with the following exceptions.

In this embodiment, the CPU 110 of the server 100 functions as a mail creation unit 126, as well as a refill management unit 122 and refill determination unit 124, by executing a program stored in the memory 120.

In this embodiment, the printer 200 includes as a main component a display panel 260 that comprises a liquid crystal panel or the like and displays desired information to the user, in addition to a CPU 210, a memory 220, a network I/F circuit 230, a cartridge information access unit 240 and a printer engine 250.

### II-B. Operation of Embodiment

Because most of the operations executed on the printer 6 shown in FIG. 6 are identical to the operations executed on the first embodiment, they will not be described. The differences [from the first embodiment] are described below.

### II-B-1. Operations Executed on Server

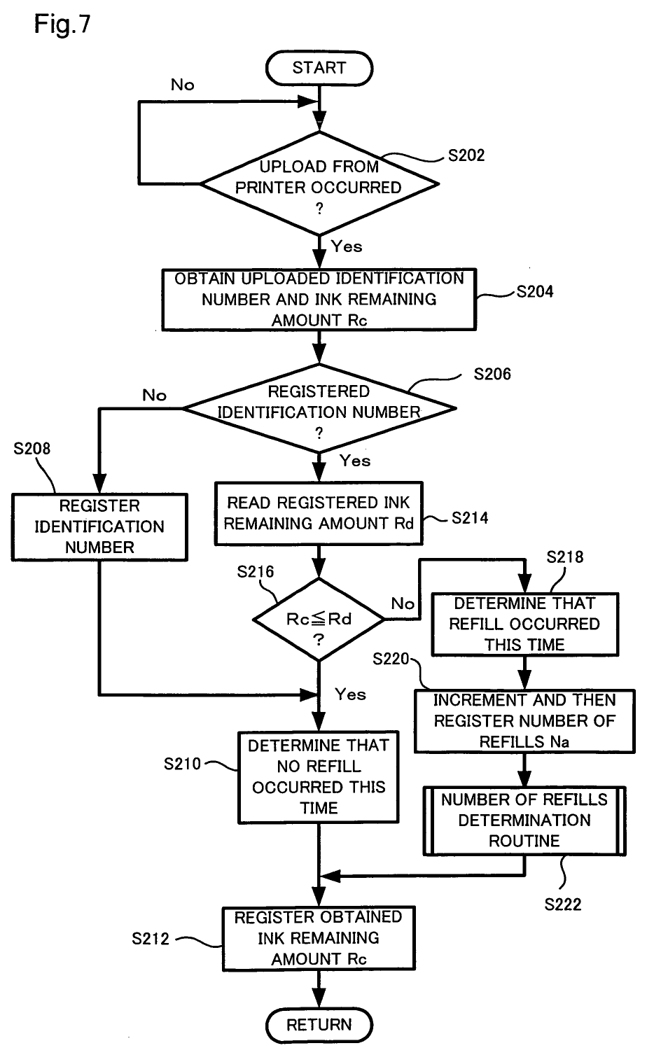

The operations executed on the server shown in FIG. 6 will now be described. FIG. 7 is a flow chart showing the operations of a refilled cartridge determination routine executed on the server 100 shown in FIG. 6.

When the processing routine shown in FIG. 7 is begun, the CPU 110 functions as a refill management unit 122 and refill determination unit 124, as described above. As between these functions, the refill management unit 122 first determines whether or not an ink remaining amount and the like have been uploaded from any of the printers over the network 300 (step S202), and where there is no upload, it stands by until such information is uploaded. When such information is thereafter uploaded from any of the printers, the refill management unit 122 obtains the uploaded identification number and ink remaining amount via the network I/F circuit 130 (step S204). The ink remaining amount obtained via uploading here is deemed Rc [%].

The refill management unit 122 then determines whether or not the identification number obtained via uploading is a registered identification number with reference to the remaining amount management table 142 and the like on the hard disk device 140 (step S206). If the identification number obtained via uploading is unregistered, it is registered in the remaining amount management table 142 and refill management table 144 (step S208).

The refill determination unit 124 determines that the ink cartridge having the identification number obtained via uploading was not refilled this time (step S210), and the refill management unit 122 registers in the remaining amount management table 142 the ink remaining amount Rc previously obtained via uploading in association with the previously registered identification number (step S112), whereupon the processing routine ends.

The remaining amount management table 142 shown in FIG. 6 will now be described using FIG. 4 described above. In this embodiment as well, the identification number and ink remaining amount are registered in association with each other for each ink cartridge in the remaining amount management table 142, as described above. These registered items of information comprise information regarding ink cartridges that are or were mounted in the printers connected to the network 300.

Therefore, as described above, where a new ink cartridge replaces the existing ink cartridge in the printer 200, for example, the identification number (such as ‘#12345’) and ink remaining amount of the existing ink cartridge are uploaded from the printer 200 to the server 100 and registered in the remaining amount management table 142 until replacement, as shown in FIG. 4, but after replacement, the identification number (such as ‘#32346’) and ink remaining amount of the new ink cartridge are uploaded and newly registered in the remaining amount management table 142, as shown in FIG. 4.

On the other hand, where it is determined in step S206 that the identification number obtained via uploading is already registered, the refill management unit 124 reads from the remaining amount management table 142 on the hard disk device 140 the ink remaining amount corresponding to such registered identification number. The read ink remaining amount is deemed Rd [%].

The refill determination unit 124 then compares the ink remaining amount Rc obtained via uploading with the ink remaining amount Rd read from the remaining amount management table 142 to determine whether or not the ink remaining amount Rc equals or is smaller than the ink remaining amount Rd registered in the remaining amount management table 412, i.e., whether Rc≦Rd (step S216). In this case, it is preferred that the above determination be carried out taking into account ink remaining amount measurement errors.

If it is determined that the ink amount Rc obtained via uploading equals or is smaller than the ink remaining amount Rd registered in the remaining amount management table 142, the refill determination unit 124 determines that the ink cartridge having the identification number obtained via uploading was not refilled this time (step S210), and the refill management unit 122 registers the ink amount Rc obtained via uploading by overwriting the ink amount corresponding to such registered identification number in the remaining amount management table 142 (step S112), whereupon the processing routine ends.

Conversely, where the ink amount Rc obtained via uploading is larger than the ink remaining amount Rd registered in the remaining amount management table 142, the refill determination unit 124 determines that the ink cartridge having the identification number obtained via uploading was refilled this time (step S218).

In other words, in the printer 200, if the ink cartridge is refilled with ink, ‘5%’ is uploaded as the ink remaining amount in connection with the identification number of the ink cartridge, which is ‘#24153’, for example, as described above, and is registered in the remaining amount management table 142 as shown in FIG. 4 until the refill, and after the refill, because the amount of ink has increased in the same ink cartridge to the same extent of the refill ink, as shown by the dotted lines in FIG. 4, ‘100%’ is uploaded, for example, as the ink remaining amount for the same ink cartridge identification number ‘#24153’.

Therefore, where the ink remaining amount Rc obtained via uploading (‘100%’ in the example described above) is larger than the ink remaining amount Rd registered in the remaining amount management table 142 with regard to the same identification number (‘#24153’ in the example described above), the ink cartridge can be determined to be a refilled cartridge.

The refill management unit 122 then increments the number of refills corresponding to the identification number obtained via uploading in the refill management table 144 on the hard disk device 140 and registers the resulting sum therein (step S220).

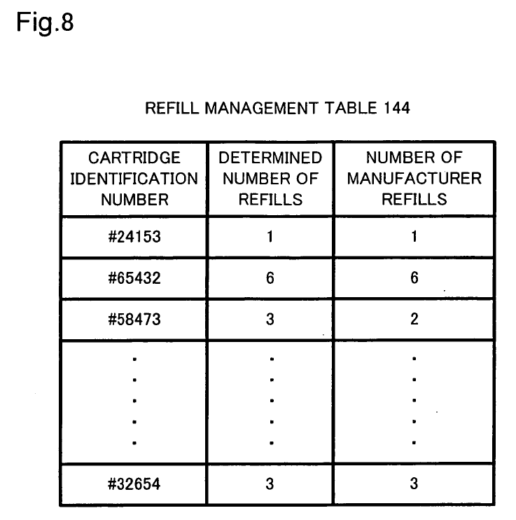

FIG. 8 is an explanatory drawing showing one example of the refill management table 144 shown in FIG. 6. As shown in FIG. 8, the identification number, determined number of refills and number of manufacturer refills are registered for each ink cartridge in association with one another in the refill management table 144. Here the ‘determined number of refills’ refers to the number of times that the ink cartridge corresponding to an identification number has been determined by the refill determination unit 124 to be a refilled cartridge, and the ‘number of manufacturer refills’ refers to a number indicating the number of refills obtained from the printer manufacturer or the like. The ‘number of manufacturer refills’ is described in detail below. In this embodiment, the determined number of refills is deemed Na and the number of manufacturer refills is deemed Nb. These registered items of information also comprise information regarding ink cartridges that are or were mounted in the printers connected to the network 300.

Where it is determined for the first time by the refill determination unit 124 that the ink cartridge having the identification number obtained via uploading is a refilled cartridge, the refill management unit 122 registers ‘1’ in the refill management table 144 as the number of refills for that identification number. Where the number of times that the ink cartridge having the identifying number obtained via uploading has been determined by the refill determination unit 124 to be a refilled cartridge is two or more, the refill management unit 122 increments the number of refills for that registered identification number and registers the resulting sum in the refill management table 144.

Therefore, for example, in the printer 200, where an ink cartridge having the identification number ‘#24153’ is refilled for the first time, as described above, ‘1’ is registered as the number of refills corresponding to that identification number ‘#24153’ in the refill management table 144, as shown in FIG. 8.

Where an ink cartridge having the identification number ‘#65432’ has been refilled for the sixth time, for example, the registered number of refills ‘5’ for that identification number ‘#65432 is incremented and ‘6’ is registered in the refill management table 144, as shown in FIG. 8.

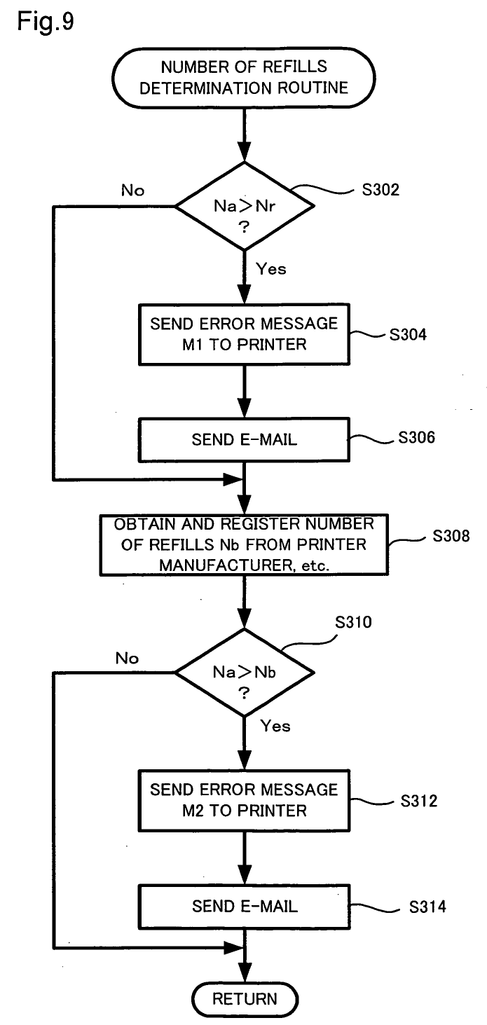

The refill management unit 122 and refill determination unit 124 then move to a number of refills determination routine shown in FIG. 9 (step S222). FIG. 9 is a flow chart showing the operations of the number of refills determination routine shown in FIG. 7.

When the processing routine shown in FIG. 9 is begun, the refill determination unit 124 reads the determined number of refills Na corresponding to the identification number obtained via uploading from the refill management table 144, and determines whether or not the determined number of refills Na exceeds a preset maximum limit Nr (step S302). Here the ‘maximum limit Nr’ is the allowable maximum number of times that the same ink cartridge can be repeatedly refilled. If the same ink cartridge is refilled in excess of this maximum limit, there is a risk of printing quality deterioration or loss of printer durability.

If it is determined that the determined number of refills Na has not exceeded the maximum limit Nr, the refill management unit 122 proceeds to the operation of step S308.

Conversely, if the determined number of refills Na exceeds the maximum limit Nr, the refill management unit 122 sends the following error message over the network 300 via the network I/F circuit 130 to the printer from which the identification number and number of refills information was uploaded due to the risk of reduced printing quality and loss of durability (step S304).

Error message M1: “The recommended number of refills for this ink cartridge has been exceeded. This may result in deterioration in printing quality or shorten the life of the printer engine.”

The mail creation unit 126 creates an e-mail indicating that the determined number of refills Na has exceeded the maximum limit Nr, and sends it to the administrator and a service representative from the network I/F circuit over the network 300 (step S306). Here ‘the administrator’ refers to the person who manages the refill management system of this embodiment, and ‘a service representative’ refers to a service person who can perform maintenance of the printer 200 and the like. It is preferred that the e-mail include such information as the identification number of the ink cartridge needing replacement, the name of the printer in which the ink cartridge is mounted and the determined number of refills Na. It is also acceptable if the e-mail is sent to a service center instead of to a service representative.

Therefore, if the maximum limit Nr is set to ‘5’, where an ink cartridge having the identification number ‘#65432’ has been refilled for the sixth time, for example, as shown in FIG. 8, ‘6’ is read from the refill management table 144 as the determined number of refills, and because this exceeds the maximum limit Nr, that is, ‘5’, transmission of the error message M1 and an e-mail are executed as described above.

The refill management unit 122 then accesses the server (not shown) managed by the printer manufacturer or the like via the network I/F circuit 130 over the network 300, and obtains the number of manufacturer refills Nb corresponding to the identification number obtained via uploading based on such identification number, and registers it in the refill management table 144 (step S308).

Here ‘the number of manufacturer refills’ refers to the number of times the ink cartridge having the identification number obtained via uploading has been refilled with ink by the printer manufacturer or the like. Specifically, as part of their after-sale services, the printer manufacturer or the like collects from users ink cartridges that no longer contain ink, refills them with ink and returns them to the original users. When an ink cartridge is refilled with ink by the printer manufacturer or the like, because the ink manufactured by the printer manufacturer or the like, i.e., the ink that is the most appropriate for the printer, is used, it is very unlikely that the printing quality will deteriorate or the durability of the printing engine will be impacted.

When an ink cartridge is refilled with ink by the printer manufacturer or the like, the identification number of such ink cartridge is automatically registered in the above server managed by the printer manufacturer or the like, and the number of refills performed by the printer manufacturer or the like is incremented for each refill.

The refill determination unit 124 reads the determined number of refills Na and the number of manufacturer refills Nb corresponding to the identification number obtained via uploading from the refill management table 144, and determines whether or not the determined number of refills Na exceeds the number of manufacturer refills Nb (step S310).

Where it is determined that the determined number of refills Na equals the number of manufacturer refills Nb, the refill management unit 122 determines that all refills performed with regard to the ink cartridge having the above identification number were carried out by the printer manufacturer or the like, and the CPU 210 returns to the processing routine shown in FIG. 7.

Conversely, where the determined number of refills Na exceeds the number of manufacturer refills Nb2, indicating that a refill performed with regard to the ink cartridge having the above identification number was carried out by a party other than the printer manufacturer or the like and that as a result printing quality may deteriorate or printer engine durability may be impacted in the printer 200, the refill management unit 122 sends the following error message M2 over the network 300 via the network I/F circuit 130 to the printer that uploaded the identification number and number of refills information (step S312).

Error message M2: “The ink refill was not performed by an authorized person. This could cause a deterioration in printing quality or shorten the life of the printer engine.”

The mail creation unit 126 creates an e-mail indicating that the determined number of refills Na has exceeded the maximum limit Nr and sends it to the administrator and a service representative from the network I/F circuit over the network 300 (step S314), whereupon the processing routine shown in FIG. 7 is returned to. It is preferred that the e-mail include such information as the identification number of the ink cartridge to be maintained, the determined number of refills Na and the number of manufacturer refills.

Therefore, if an ink cartridge having the identification number ‘#58473’ has been refilled for the third time and ‘2’ is obtained from the printer manufacturer or the like as the number of manufacturer refills, for example, ‘3’ and ‘2’ are read from the refill management table 144 as the determined number of refills and the number of manufacturer refills, respectively, as shown in FIG. 8, and because the determined number of refills exceeds the number of manufacturer refills, transmission of the error message M2 and e-mail are executed as described above.

With reference to FIG. 7 once more, the refill management unit 122 registers the ink remaining amount Rc obtained via uploading by overwriting the ink remaining amount corresponding to the registered identification number obtained via uploading in the remaining amount management table 142 (step S212), whereupon the processing routine ends.

Therefore, as described above, if an ink cartridge having the identification number ‘#24153’ has been refilled with ink and the identification number ‘#24153’ and the ink remaining amount ‘100%’ are uploaded from the printer 200 to the server 100, the new ink remaining amount ‘100%’ is registered by overwriting the existing registered ink remaining amount ‘5%’ for the identification number ‘#24153’ in the remaining amount management table 142, as shown in FIG. 4.

In this way, the server 100 keeps track of the ink remaining amount, the determined number of refills and the number of manufacturer refills with regard to each ink cartridge that has been mounted in any of the printers connected to the network 300.

### II-B-2. Operations Executed on Printer

The operations executed on the printer of this embodiment that are different from those executed on the first embodiment will now be described. Because all of the printers carry out the identical operations, these operations will be described with regard to the printer 200 as a representative example.

As described above, when the error message M1 or M2 is sent from the server 100 to the printer 200 over the network 300, the CPU 210 receives it via the network I/F circuit 230 and displays it on the display panel 260.

The attention of the user of the printer 200 is accordingly drawn to the warning that the printing quality may deteriorate or printer engine durability may be impacted.

### II-C. Effect of Embodiment

In this embodiment, when an ink cartridge mounted in any of the printers connected to the network 300 has been refilled with ink, it can be easily determined whether or not the number of refills (the determined number of refills) Na exceeds the maximum limit Nr, and if it does, a warning can be issued to draw the user‘s attention.

In addition, it can be easily determined whether or not the ink refill was performed by the printer manufacturer or the like, and if it was done by a party other than the printer manufacturer or the like, a warning can be issued to draw the user's attention.

According to this embodiment, adverse impacts on the printer due to excessive refills of the same consumable item container or ink refills by a party other than the printer manufacturer or the like can be prevented.

### III. Variations

The present invention is not limited to the embodiments and examples described above, and may be implemented in various other forms within the essential scope thereof.

In the second embodiment described above, the error message M1 or M2 sent from the server 100 was displayed on the display pane 200, but the present invention is not limited to this implementation, and where the printer 200 functions as a Web server, for example, a printer management Web page may be offered by the printer 200 and the message M1 or M2 sent from the server may be published thereon. In this case, the user of the printer 200 can view the Web page by connecting an information terminal such as a personal computer to the network 300 and accessing the Web page offered by the printer 200 using the information terminal. In this case, the system administrator and printer service personnel can also view the Web page using the same method.

In the second embodiment described above, an e-mail was sent from the server 100 to the system administrator and a printer service representative, but it is also acceptable if such e-mail is sent to the user of the printer.

In the embodiments described above, the ink cartridge 270 included a remaining amount detection sensor 272, but it is also acceptable if the printer 200 includes a remaining amount detection sensor and detects the ink remaining amount in the ink cartridge mounted therein. In addition, in the embodiments described above, the ink remaining amount obtained from the remaining amount detection sensor 272 was written in the memory 220 in the printer 200, but it may be written in the IC 274 of the remaining amount detection sensor 272 or in both. Furthermore, instead of the IC 274, a memory may be used in the ink cartridge 270.

In the embodiments described above, the ink remaining amount was detected without using terms indicating stages, but such detection may be performed in terms of the three stages of ‘full’, ‘low’ and ‘empty’ or the two stages of ‘full’ and ‘empty’. For example, when a two-stage method is used, if the ink remaining amount obtained via uploading is ‘full’ and the ink remaining amount registered in the remaining amount management table 142 is ‘empty’ regarding a certain identification number, because that indicates an increase in the ink amount, the ink cartridge having that identification number is determined to be a refilled cartridge.

In the embodiments described above, an inkjet printer was described as an example of the device connected to a network, but the present invention is not limited to this implementation, and can be applied in any of various other types of printer, such as a laser printer, thermal printer or dye-sublimation printer. In such a case, the consumable item container in a laser printer is a toner cartridge and the consumable item comprises toner, for example. In a thermal printer or dye-sublimation printer, the consumable item container is a ribbon cartridge or the like, and the consumable item is an ink ribbon or the like. The application of the present invention is not limited to these printers, and the present invention may be applied in a copying machine, facsimile machine or multifunction peripheral.

Although not described in the above descriptions of the embodiments, where confidentiality is a concern, encrypted information and authentication are preferably employed for the communication between the server 100 and the printers.

In the embodiments described above, an identification number was used to identify an ink cartridge, but the present invention is not limited to this implementation. Anything that is identifiable, including symbols, signs or letters, may be used.

The above embodiments were described based on the ink remaining amount in the ink cartridge, but the present invention is not limited to this implementation, and instead of the ink remaining amount, the consumed ink amount or refillable ink amount may be used. In that case, the method of determination in step S20 of FIG. 2 or step S116 of FIG. 3 must be changed depending on the type of amount used.

In the embodiments described above, when the current ink amount Rb obtained from the ink cartridge is smaller than the previously uploaded ink remaining amount Ra by the amount a, the identification number and current ink remaining amount were uploaded to the server 100 and the uploaded identification number and ink remaining amount were written to the memory 220, but the present invention is not limited to this implementation. For example, it is acceptable if the identification number and current ink remaining amount obtained from the ink cartridge are written to the memory as needed, and the identification number and ink remaining amount obtained from the ink cartridge are uploaded to the server 100 only when the currently obtained identification number is different from the previously written identification number or when the currently obtained ink remaining amount is different from the previously written ink remaining amount.

Alternatively, it is acceptable if the identification number and current ink remaining amount are obtained from the ink cartridge as needed and all of the obtained information is written to the memory 220 in the printer to leave a history of identification number/ink remaining amount changes, and the history information is uploaded to the server only when a request for upload is subsequently received from the server 100.

In the embodiments described above, because the number of refills or the determined number of refills and number of manufacturer refills are maintained and kept track of for each ink cartridge identification number in the server 100, it is acceptable if the printer obtains from the server 100 and stores these numbers of refills with regard to the ink cartridge currently mounted in the printer, and outputs them via printing to inform the user.

In such a case, if the printer cannot communicate with the server 100 over the network and cannot obtain the above numbers of refills, the printing function may be temporarily put on hold to disable printing for the time being.

Where the printer has a new cartridge detection sensor that detects whether the ink cartridge mounted in the printer is a new cartridge, it is acceptable if, when such ink cartridge is detected to be a new cartridge, the printer does not check with the server regarding the number of refills performed to the currently mounted ink cartridge.

Furthermore, when it is detected by the printer that the ink cartridge currently mounted therein has a number of refills in excess of a preset prescribed maximum limit, the printing function may be temporarily put on hold to disable printing while such ink cartridge remains in the printer.

1. A refill management system that comprises a server and devices connected to the server over a network and that keeps track of refills of the consumable item container mounted in each the device,
wherein each the device sends to the server over the network identification information by which to identify the consumable item container mounted therein and remaining amount related information that indicates the remaining amount of the consumable item in the consumable item container or an amount related thereto, and
wherein the server comprises a first management table that stores and associates, for each the consumable item container, the identification information and the remaining amount related information, where identification information sent from a device is already registered in the first management table, compares a first remaining amount derived from the remaining amount related information sent from the device and a second remaining amount derived from remaining amount related information previously registered in the first management table in association with the identification information sent from the device, and where the first remaining amount is larger than the second remaining amount, determines that the consumable item container mounted in the device has been refilled.

2. The refill management system according to claim 1, wherein the server further comprises a second management table that stores and associates, for each the consumable item container, identification information and the number of times that the consumable item container have been refilled, and where it is determined that a consumable item container has been refilled, the number of refills registered in the second management table in association with the identification information for the consumable item container is incremented.

3. The refill management system according to claim 1, wherein the server registers the remaining amount related information sent from any of the devices in the first management table in association with the sent identification information.

4. The refill management system according to claim 1, wherein each the device comprises a reader that reads the identification information from the consumable item container mounted therein and a detector that detects the remaining amount of the consumable item in the consumable item container or a different amount related thereto.

5. A server that is connected to devices over a network and can keep track of refills of the consumable item container mounted in each the device, wherein the server comprises, for each the consumable item container, a first management table storing identification information by which to identify the consumable item container and remaining amount related information that indicates the remaining amount of the consumable item in the consumable item container or an amount related thereto,
wherein the server receives from any of the devices the identification information for the consumable item container mounted therein and the remaining amount related information regarding the consumable item container, and
where the identification information received from the device is already registered in the first management table, compares a first remaining amount derived from the remaining amount related information sent from the device and a second remaining amount derived from remaining amount related information previously registered in the first management table in association with the identification information sent from the device, and where the first remaining amount is larger than the second remaining amount, determines that the consumable item container mounted in the device has been refilled.

6. The refill management system according to claim 5, wherein the server further comprises for each the consumable item container a second management table that stores and associates, for each the consumable item container, the identification information and the number of refills representing the number of times that the consumable item container has been refilled, and
where it is determined that any of the consumable item containers has been refilled, increments the number of refills registered in the second management table in association with the identification information of the consumable item container.

7. The refill management system according to claim 5, wherein the server registers the received remaining amount related information in the first management table in association with the received identification information.

8. A device connected to a server that can keep track of refills of consumable item containers over a network, wherein the device sends to the server over the network identification information regarding the consumable item container mounted therein and remaining amount related information that indicates the remaining amount of the consumable item in the consumable item container or an amount related thereto.

9. The refill management system according to claim 8, wherein the device includes a reader that reads the identification information from the consumable item container mounted therein and a detector that detects the remaining amount of the consumable item in the consumable item container or an amount related thereto.

10. A refill management method by which a server connected to devices over a network keeps track of refills of consumable item containers mounted in the devices, the refill management method comprising the steps of:
(a) sending from any of the devices to the server over the network identification information by which to identify the consumable item container mounted the device and remaining amount related information that indicates the remaining amount of the consumable item in the consumable item container or an amount related thereto;
(a) providing a first management table that stores and associates, for each the consumable item container, the identification information and the remaining amount related information in the server;
(c) where the identification information sent from the device is already registered in the first management table, comparing a first remaining amount derived from the remaining amount related information sent from the device and a second remaining amount derived from the remaining amount related information previously registered in the first management table in association with the identification information sent from the device in the server; and
(d) where the first remaining amount is larger than the second remaining amount, determining that the consumable item container mounted in the device has been refilled in the server.

11. The refill management method according to claim 10, wherein the step (a) comprises, in addition to the step of providing the first management table, the step of providing a second management table that stores and associates, for each the consumable item container, the identification information and the number of times that the consumable item container has been refilled in the server, the refill management method further comprising the step of:
(e) where it is determined that a consumable item container has been refilled, incrementing the number of refills registered in the second management table in association with the identification information of the consumable item container in the server.

12. A computer program product that is used on a server connected to devices over a network and that enables the server to keep track of refills of consumable item containers mounted in the devices, the computer program product comprising:
a first program code of accessing a first management table that is prepared in the server and that stores and associates, for each the consumable item container, identification information by which to identify the consumable item container and remaining amount related information that indicates the remaining amount of the consumable item in the consumable item container or an amount related thereto;
a second program code of receiving from any of the devices over the network the identification information for the consumable item container mounted therein and the remaining amount related information regarding the consumable item container, as well as for, where the identification information sent from the device is already registered in the first management table, comparing a first remaining amount derived from the remaining amount related information sent from the device to a second remaining amount derived from remaining amount related information previously registered in the first management table in association with the identification information sent from the device;
a third program code of, where the first remaining amount is larger than the second remaining amount, determining that the consumable item container mounted in the device has been refilled; and
a computer-readable medium on which the program codes are stored.

13. The computer program product according to claim 12, the computer program product further comprising:
a forth program code of accessing a second management table prepared in the server and in which are stored and associated, for each the consumable item container, the identification information and the number of times that the consumable item container has been refilled; and
a fifth program code of, where it is determined that a consumable item container has been refilled, incrementing the number of refills registered in the second management table in association with the identification information for the consumable item container.

14. A refill management system that includes a server and devices connected to the server over a network and that keeps track of refills of the consumable item container mounted in each the device,
wherein the server comprises a management table that stores and associates, for each the consumable item container, identification information by which to identify the consumable item container and the number of refills representing the number of times that the consumable item container has been refilled, and compares, with regard to the consumable item container mounted in each the device, the number of refills registered in the management table in association with the identification information for the consumable item container and a preset maximum limit, and where the number of refills exceeds the maximum limit, sends a predetermined message to the device, and
wherein the device receives the message sent from the server and announces it externally.

15. A refill management system that includes a server and devices connected to the server over a network and that keeps track of refills of the consumable item container mounted in each the device,
wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith, compares, with regard to the consumable item container mounted in each the device, the first number of refills and the second number of refills that are registered in the management table in association with the identification information for the consumable item container, and where the first number of refills exceeds the second number of refills, sends a predetermined message to the device; and
the device receives the message sent from the server and announces it externally.

16. A server that is connected to devices over a network and can keep track of refills with regard to the consumable item container mounted in each the device, wherein the server comprises a management table that stores and associates, for each the consumable item container, identification information by which to identify the consumable item container and the number of refills representing the number of times that the consumable item container has been refilled,
the server compares, with regard to the consumable item container mounted in each the device, the number of refills registered in the management table in association with the identification information for the consumable item container and a preset maximum limit, and where the number of refills exceeds the maximum limit, sends a predetermined message to the device.

17. A server that is connected to devices over a network and can keep track of refills with regard to the consumable item container mounted in each the device, wherein the server comprises a management table that stores and associates, for each the consumable item container, identification information by which to identify the consumable item container and the number of refills representing the number of times that the consumable item container has been refilled,
the server compares, with regard to the consumable item container mounted in each the device, the number of refills registered in the management table in association with the identification information for the consumable item container and a preset maximum limit, and where the number of refills exceeds the maximum limit, sends an e-mail to at least the administrator of the system including the server, a service representative who can perform maintenance to the device or the user of the device.

18. A server that is connected to devices over a network and can keep track of refills with regard to the consumable item container mounted in each such device, wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith,
the server compares, with regard to the consumable item container mounted in each the device, the first number of refills and the second number of refills that are registered in the management table in association with the identification information for the consumable item container, and where the first number of refills exceeds the second number of refills, sends a predetermined message to the device.

19. A server that is connected to devices over a network and can keep track of refills with regard to the consumable item container mounted in each such device, wherein the server comprises a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith,
the server compares, with regard to the consumable item container mounted in each the device, the first number of refills and the second number of refills that are registered in the management table in association with the identification information for the consumable item container, and where the first number of refills exceeds the second number of refills, sends an e-mail to at least the administrator of the system including the server, a service representative who can perform maintenance to the device or the user of the device.

20. A refill management method by which a server connected to devices over a network keeps track of refills of consumable item containers mounted in the devices, the refill management method comprising the steps of:
(a) providing a management table that stores and associates, for each the consumable item container, identification information by which to identify the consumable item container and the number of refills representing the number of times that the consumable item container has been refilled in the server;
(b) comparing, with regard to the consumable item container mounted in each the device, the number of refills registered in the management table in association with the identification information for the consumable item container and a preset maximum limit in the server;
(c) where the number of refills exceeds the maximum limit, sending a predetermined message from the server to the device; and
(d) receiving the message sent from the server and announcing it externally in the device.

21. A refill management method by which a server connected to devices over a network keeps track of refills of consumable item containers mounted in the devices, the refill management method comprising the steps of:
(a) providing a management table that stores and associates, for each the consumable item container, identification information by which to identify the consumable item container and the number of refills representing the number of times that the consumable item container has been refilled in the server;
(b) comparing, with regard to the consumable item container mounted in each the device, the number of refills registered in the management table in association with the identification information for the consumable item container and a preset maximum limit in the server; and
(c) where the number of refills exceeds the maximum limit, sending an e-mail form the server to at least the administrator of the system including the server, a service representative who can perform maintenance to the device or the user of the device.

22. A refill management method by which a server connected to devices over a network keeps track of refills of consumable item containers mounted in the devices, the refill management method comprising the steps of:
(a) providing a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith in the server;
(b) comparing, for the consumable item container mounted in each the device, the first number of refills and the second number of refills that are registered in the management table in association with the identification information for the consumable item container in the server;
(c) where the first number of refills exceeds the second number of refills, sending a predetermined message from in the server to the device; and
(d) receiving the message sent from the server and announces it externally in the device.

23. A refill management method by which a server connected to devices over a network keeps track of refills of consumable item containers mounted in the devices, the refill management method comprising the steps of:
(a) providing a management table that stores and associates, for each the consumable item container, identification information by which to identify the consumable item container, a first number of refills representing the number of times that the consumable item container has been refilled, and a second number of refills representing the number of refills that have been performed by the manufacturer who manufactured the device or a party affiliated therewith in the server;
(b) comparing, for the consumable item container mounted in each the device, the first number of refills and the second number of refills that are registered in the management table in association with the identification information for the consumable item container in the server;
(c) where the first number of refills exceeds the second number of refills, sending an e-mail from the server to at least the administrator of the system including the server, a service representative who can perform maintenance to the device or the user of the device.

24. A computer program product that is used on a server connected to devices over a network and that enables the server to keep track of refills of consumable item containers mounted in the devices, the computer program product comprising:
a first program code of accessing a management table that is prepared in the server and that stores and associates, for each the consumable item container, identification information by which to identify the consumable item container and the number of refills representing the number of times that the consumable item container has been refilled;
a second program code of comparing, with regard to the consumable item container mounted in each the device, the number of refills registered in the management table in association with the identification information for the consumable item container and a preset maximum limit;
a third program code of, where the number of refills exceeds the maximum limit, sending a predetermined message to the device; and
a computer-readable medium that stores the program codes.

25. A computer program product that is used on a server connected to devices over a network and that enables the server to keep track of refills of consumable item containers mounted in the devices, the computer program product comprising:
a first program code of accessing a management table that is prepared in the server and that stores and associates, for each the consumable item container, identification information by which to identify the consumable item container and the number of refills representing the number of times that the consumable item container has been refilled;
a second program code of comparing, with regard to the consumable item container mounted in each the device, the number of refills registered in the management table in association with the identification information for the consumable item container and a preset maximum limit;
a third program code of, where the number of refills exceeds the maximum limit, sending an e-mail to at least the administrator of the system including the server, a service representative who can perform maintenance to the device or the user of the device; and
a computer-readable medium that stores the program codes.

26. A computer program product that is used on a server connected to devices over a network and that enables the server to keep track of refills of consumable item containers mounted in the devices, the computer program product comprising:
a first program code of accessing a management table that is prepared in the server and that stores and associates, for each the consumable item container, identification information by which to identify the consumable item container, a first number of refills representing the number of times that the consumable item container has been refilled, and a second number of refills representing the number of refills that have been performed by the manufacturer of the device or a party affiliated therewith;
a second program code of comparing, for the consumable item container mounted in each the device, the first number of refills and the second number of refills that are registered in the management table in association with the identification information for the consumable item container;
a third program code of, where the first number of refills exceeds the second number of refills, sending a predetermined message to the device; and
a computer-readable medium that stores the program codes.

27. A computer program product that is used on a server connected to devices over a network and that enables the server to keep track of refills of consumable item containers mounted in the devices, the computer program product comprising:
a first program code of accessing a management table that is prepared in the server and that stores and associates, for each the consumable item container, identification information by which to identify the consumable item container, a first number of refills representing the number of times that the consumable item container has been refilled, and a second number of refills representing the number of refills that have been performed by the manufacturer of the device or a party affiliated therewith;
a second program code of comparing, for the consumable item container mounted in each the device, the first number of refills and the second number of refills that are registered in the management table in association with the identification information for the consumable item container;
a third program code of, where the first number of refills exceeds the second number of refills, sending an e-mail to at least the administrator of the system including the server, a service representative who can perform maintenance to the device or the user of the device; and
a computer-readable medium that stores the program codes.
